(19) United States
(12) Patent Application Publication
(10) Pub. No.: US 2022/0362099 A1
(43) Pub. Date: Nov. 17, 2022

(54) POWERED MASSAGE HEAD

(71) Applicant: Thrival, LLC, Steamboat Springs, CO (US)

(72) Inventors: William Smith, Vero Beach, FL (US); Cameron Smith, Steamboat Springs, CO (US); Dominic Rainville, Sainte-Julie (CA)

(21) Appl. No.: 17/827,450

(22) Filed: May 27, 2022

Related U.S. Application Data
(63) Continuation-in-part of application No. 17/180,654, filed on Feb. 19, 2021.
(60) Provisional application No. 63/051,164, filed on Jul. 13, 2020.
(60) Provisional application No. 63/116,655, filed on Nov. 20, 2020.
(60) Provisional application No. 63/128,636, filed on Dec. 21, 2020.

(51) Int. Cl. A61H 23/02

(52) U.S. Cl. CPC A61H 23/02; A61H 2201/0107; A61H 2201/5012; A61H 2201/5097; A61H 2201/0119

(57) ABSTRACT

Described is a powered massage head. The powered massage includes an exterior portion, an interior portion, a top portion, and a bottom portion. The top portion is formed to contact a portion of a user's body. A motor is housed within the interior portion and a power source within the interior portion is configured for providing power to the motor. A control mechanism within the interior portion controls the motor. The powered massage head may be formed to attached with a massage board for use, or formed to be used independently.

### CROSS-REFERENCE TO RELATED APPLICATIONS

This is a Continuation-in-Part application of U.S. application Ser. No. 17/180,654, filed in the United States on Feb. 19, 2021, entitled, “Self-Massage Device Having Interchangeable Massage Heads and Board”, which is a Non-Provisional application of U.S. Provisional Application No. 63/051,164, filed in the United States on Jul. 13, 2020, entitled, “Pso Much Better,” the entirety of which is incorporated herein by reference. U.S. application Ser. No. 17/180,654 is also a Non-Provisional application of U.S. Provisional Application No. 63/116,655, filed in the United States on Nov. 20, 2020, entitled, “Roman Arch Therapeutic Device,” and U.S. Provisional Application No. 63/128,636, filed in the United States on Dec. 21, 2020, entitled, “Electrical Platform for Receiving Removable Therapeutic Heads,” the entirety of which are incorporated herein by reference.

### BACKGROUND OF INVENTION

### (1) Field of Invention

The present invention relates to a powered massage head and, more particularly, to a powered massage head having a contained power source.

### (2) Description of Related Art

The following art defines the present state of this field:

Mollohan, U.S. Pat. No. D823,479, is the design for the PSO-RITE® massage tool. The massage tool is formed of one piece, having two vertical heads, and is not adjustable to allow for different body sizes.

PSO-SPINE™ is a product similar to the PSO-RITE® massage tool, which is intended to relieve tight muscles adjacent to the spine. The PSO-SPINE™ tool is formed of one piece, having a series of vertical-only heads that are not adjustable or interchangeable.

The PSOAS Release Tool is a massage tool designed with wheels to allow adjustment of body positioning during use. The PSOAS Release Tool is sold by a company by the same name located at 1605 W 2100 S. Salt Lake City, Utah 84119. While the PSOAS Release Tool allows adjusting of the user's body while using the tool, it is not adjustable in length to allow for different body sizes and does not include interchangeable massage heads for different types of massage.

Karvandi, U.S. Pat. No. D905,180 is the design for the HIP HERO Psoas Massager. The HIP HERO heads are adjustable via a very limited sliding mechanism; however, the heads are not removable or interchangeable for different types of massage.

Howard, U.S. Pat. No. 6,315,742 describes a massaging device for massage along the spine comprising a hand-held frame with rollers.

Vitko, U.S. Pat. No. 6,390,997 describes a back stimulation device comprising a frame with a headrest, axles, and roller balls.

Emmel, U.S. Publication No. 2006/0247562 describes a manipulation device having a pair of protrusions directed upward and spaced to allow room for a person's spinal column or large muscle groups or joints to be suspended between said protrusions.

Masek, U.S. Publication No. 2009/0012435 describes an adjustable massage tool comprising a base, a first threaded shank engaged with a first threaded fastener, a second threaded shank engaged with a second threaded fastener, a first pressure ball attached to the first threaded shank, and a second pressure ball attached to the second threaded shank, wherein the pressure balls are configured to extend upwards from the base when the base is placed on the ground.

Chongsu LEE, U.S. Publication No. 2020/0297570 describes a back therapy apparatus comprising manipulating elements movably mounted to a frame and controlled by a controller coupled to the manipulating elements.

Burns, et al., U.S. Publication No. 2020/0323733 describes a portable therapeutic device comprising a body with a recessed region and massage balls within the recessed region, and a power source coupled to the massage balls.

The following references are also relevant to the field of invention: U.S. D615,662, U.S. D698,035, U.S. D697,630 U.S. D687,958, and U.S. Pat. No. 9,687,416.

The prior art teach massage devices with rollers, balls, and massage heads in various arrangements. However, the prior art does not teach a single powered massage head that for targeting different body parts and different body sizes.

### SUMMARY OF THE INVENTION

The present invention relates to a powered massage head and, more particularly, to a powered massage head having a contained power source. The powered massage head comprises an exterior portion, an interior portion, a top portion, and a bottom portion. The top portion is formed to contact a portion of a user's body. The powered massage head further comprises a motor within the interior portion, a power source within the interior portion and configured for providing power to the motor, a control mechanism for controlling the motor, and a printed circuit board housed within the interior portion and connected with the control mechanism.

In another aspect, a protrusion extends from the bottom portion, and the protrusion is formed to be removably inserted into a massage board.

In another aspect, the exterior portion extending from the bottom portion to the top portion is substantially curved.

In another aspect, the exterior portion extending from the bottom portion to the top portion is substantially straight.

In another aspect, the top portion forms an arch having a first end and a second end.

In another aspect, the powered massage head further comprises a printed circuit board housed within the interior portion.

In another aspect, the motor is configured to cause a vibratory action of the exterior portion.

In another aspect, the powered massage head further comprises an outer covering having an aperture therein, wherein the outer covering fits over at least a portion of the top portion.

In another aspect, the invention comprises a control element configured to send signals to the printed circuit board.

In another aspect, the control element is a wireless remote.

In another aspect, the control element is a mobile application on a mobile device.

The present invention also relates to a method of forming a powered massage head. The method comprises acts of forming an exterior portion, an interior portion, a top portion, and a bottom portion, wherein the top portion is formed to contact a portion of a user's body. The method further comprises acts of positioning a motor within the interior portion; positioning a power source within the interior portion and connecting the power source with the motor; configuring the power source to provide power to the motor; and positioning a printed circuit board configured to control the motor within the interior portion.

In another aspect, a protrusion extending from the bottom portion is formed, wherein the protrusion is formed to be removably inserted into a massage board.

In another aspect, the exterior portion extending from the bottom portion to the top portion is formed to be substantially curved.

In another aspect, the exterior portion extending from the bottom portion to the top portion is formed to be substantially straight.

In another aspect, the top portion is formed as an arch having a first end and a second end.

In another aspect, a printed circuit board is positioned within the interior portion.

In another aspect, an outer covering having an aperture therein is formed, and the outer covering is positioned over at least a portion of the top portion of the massage head.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1A is a side-view illustration of a powered massage head formed for attachment to a massage board according to embodiments of the present disclosure;

FIG. 1B is a bottom, perspective-view illustration of a powered massage head formed for attachment to a massage board according to embodiments of the present disclosure;

FIG. 2 is an illustration of a massage board according to embodiments of the present disclosure;

FIG. 3 is an exploded-view illustration of a powered massage head according to embodiments of the present disclosure;

FIG. 4 is a side-view illustration of a curved stand-alone powered massage head according to embodiments of the present disclosure;

FIG. 5 is a side-view illustration of a straight stand-alone powered massage head according to embodiments of the present disclosure;

FIG. 6 is a top, perspective-view illustration of an arched powered massage head according to embodiments of the present disclosure;

FIG. 7A is a front, perspective-view illustration of an outer covering and powered massage head according to embodiments of the present disclosure;

FIG. 7B is a top, perspective-view illustration of an outer covering and powered massage head according to embodiments of the present disclosure;

FIG. 7C is front-view illustration of an outer covering and powered massage head according to embodiments of the present disclosure; and

FIG. 7D is a front-view illustration of an outer covering and powered massage head, showing the top of the powered massage head coming through the outer covering according to embodiments of the present disclosure.

### DETAILED DESCRIPTION

The present invention relates to a powered massage head and, more particularly, to a powered massage head having a contained power source. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

### (1) Specific Details of Various Embodiments

(1.1) Powered Self-Massage Head

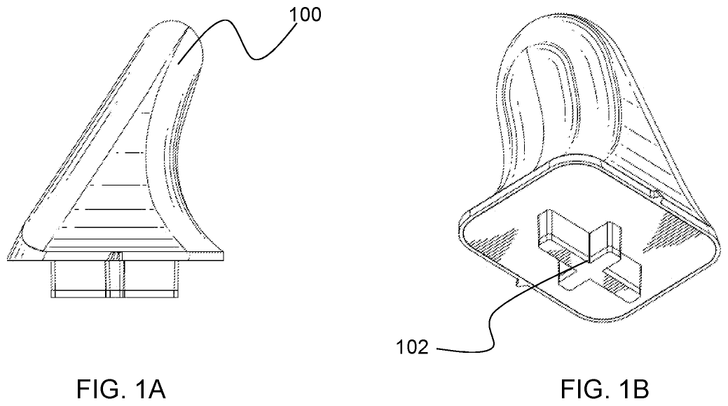

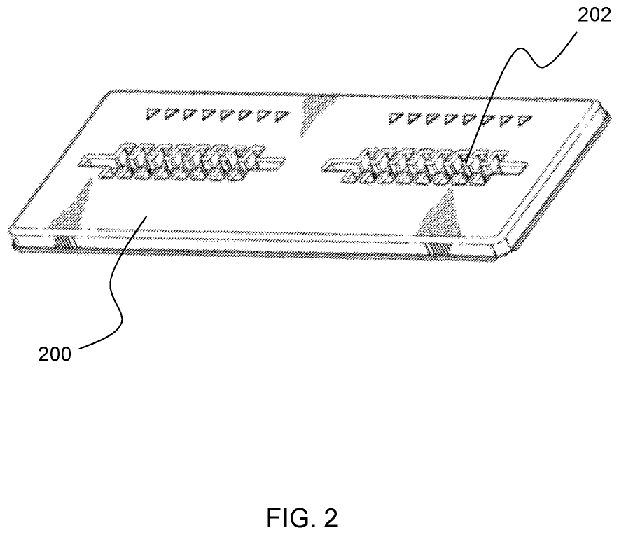

Described herein is a therapeutic, powered self-massage head intended to release muscle tension for various abdomen, leg, back and neck muscle groups, including the iliopsoas, gluteus maximus, quadratus lumborum, and piriformis. In the embodiment shown in FIGS. 1A and 1B, the powered massage head 100 is formed to be inserted into a massage board (shown in FIG. 2) that may be placed on the floor or other flat, supportive surface. The massage head 100 may include an extension element, or protrusion 102, for attachment to the massage board. In one embodiment, the protrusion 102 extends in the shape of a “cross” or “plus” from the bottom of the massage head 100, as shown in FIG. 1B. This protrusion 102 is the portion of the massage head 100 that is inserted into the massage board to provide a secure coupling.

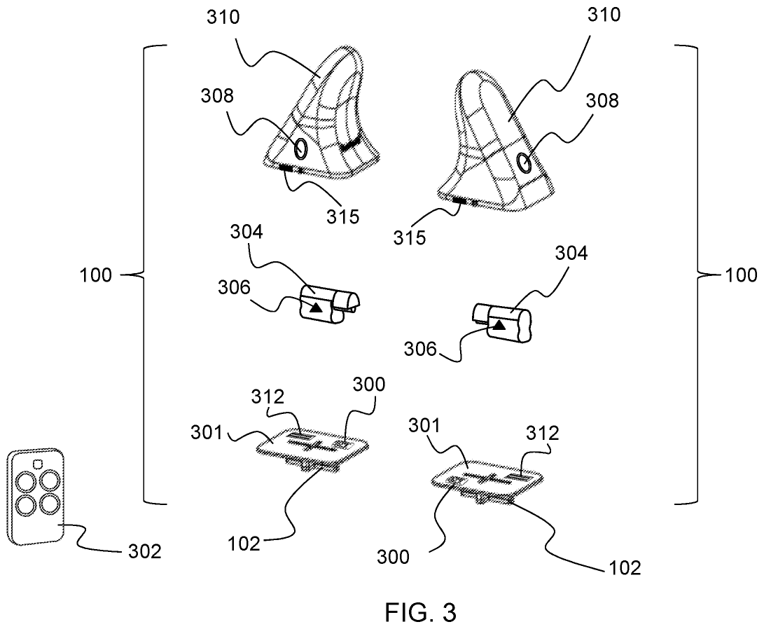

FIG. 2 depicts an embodiment of a massage board 200 according to this disclosure. The massage board 200 may be formed of a single rectangular planar element or two (or more) planar elements that can be secured together (e.g., snap-fit mechanism, interlocking mechanism). A multi-piece design would allow for easy portability and may be sized to fit within a small travel bag/case. In the embodiment illustrated in FIG. 2, the massage board 200 comprises two separate groupings of slots 202 (or indentations) formed within the surface of the massage board 200. As shown in FIG. 2, each grouping of slots 202 is a continuous, or connected, sequence of parallel indentations with one indentation running perpendicularly across the sequence of parallel indentations, similar to a series of “plus” signs. The slots 202 are formed to receive the powered massage head 100. The locking mechanism of the powered massage head 100 to the massage board 200 may be a snap-fit, press-fit, or pressure mechanism. This type of fit is also known as an interference fit. The attachment between the powered massage head 100 and the massage board 200 may be snug such that the powered massage head 100 will stay secured to the massage board 200 during use while the powered massage head 100 is vibrating. An additional locking mechanism (FIG. 3; 315) that connects the powered massage head 100 to the massage board 200 may also be implemented.

A user positions the massage head 100 within the desired slot 202 and then presses down on the powered massage head 100 to lock the massage head 100 into place on the massage board 200. In order to release/remove a massage head 100, the user then pulls the massage head 100 up and out of the slot 202 with a small amount of force. One or more massage heads 100 can be positioned into the massage board 200 and independently turned on, independently or simultaneously, to elicit a functional response, such as vibration and/or heat, as described below.

The massage head 100 described herein is formed such that it contains its own power source. FIG. 3 is an exploded-view illustration of the powered massage head 100 described herein. In one or more embodiments, a printed circuit board (PCB) 300 may be housed in the interior of the massage head 100. In the embodiment illustrated in FIG. 3, the PCB 300 may be attached with a bottom portion 301 of the powered massage head 100; however, other locations/positions for the PCB 300 within the massage head 100 are possible. The PCB 300 may include a microprocessor that implements Bluetooth® technology to wirelessly, transmit data over relatively short distance from one device to another. The PCB 300 may communicate with a mobile application on a separate device (e.g., smartphone, tablet, mobile device), a wireless remote 302, and/or one or more other massage heads 100 to control various types of motors 304 within the massage head 100. The wireless remote 302 may send a signal to the PCB 300 on the massage head 100 that activates the system. The PCB 300 may be configured to change intensity and type of vibration if the type of motor 304 in the massage head 100 requires separate connections for those functions. As understood by one skilled in the art, other control mechanisms are possible other than a PCB.

Additionally, a rechargeable battery 306 is housed within the massage head 100 and connected with the PCB 300 to provide power to the PCB 300. In one or more embodiments, the motor 304 vibrates or delivers percussion therapy via a button/switch 308 on the powered self-massage head 100. One or more massage heads 100 (typically two) are activated by the button/switch 308 on the massage head 100 that, when placed in the “on” position, provides battery power to the motor 304 inside the massage head 100. Two massage heads 100 may be paired with one another via Bluetooth® technology, such that any action applied to control one of the massage heads 100 will have the same effect on the other paired massage head 100. In the embodiment shown in FIG. 3, the button/switch 308 is positioned on a top portion 310 of the massage head 100; however, it could alternatively be positioned on the bottom portion 301. Alternatively, the massage head 100 may be powered by a remote switch or button via the wireless remote 302, or via an application on a device, such as a smartphone or tablet.

The wired or wireless remote 302 may also change the vibration volume setting to apply less or more vibration to the tip/edge of the curved massage head 100. The top portion 310 of the massage head 100 can be one piece of injection molded plastic or, in an alternate embodiment, two pieces of injection molded plastic such that the tip (upper portion) of the massage head 100 (which can be made out of a different material than the rest of the head, such as an elastomeric material) can flex and move somewhat independently from the larger base lower portion) of the massage head 100.

In addition to controlling a vibratory mechanism of each massage head 100, the PCB 300 may also be configured to be able to control heating elements 312 within the massage head 100. As can be appreciated by one skilled in the art, the heating elements 312 may be wire wound, etched foil, or any suitable mechanism for implementing heat in the massage head 100.

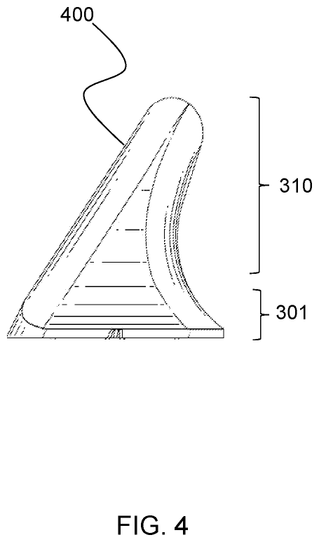

FIG. 4 depicts another embodiment of a powered massage head 400 which is a stand-alone massage head. This embodiment of a powered massage head 400 does not include the protrusion at its bottom portion and does not attach to a massage board. This embodiment of the powered massage head 400 may be placed on the floor (or other suitable substantially flat surface) prior to use and functions completely independent from a massage board. When positioned on the floor, or other flat surface, the weight of the user's body on one or more powered massage heads 400 will prevent each powered massage head 400 from moving.

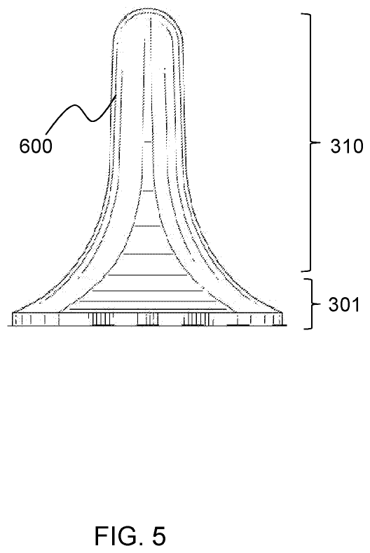

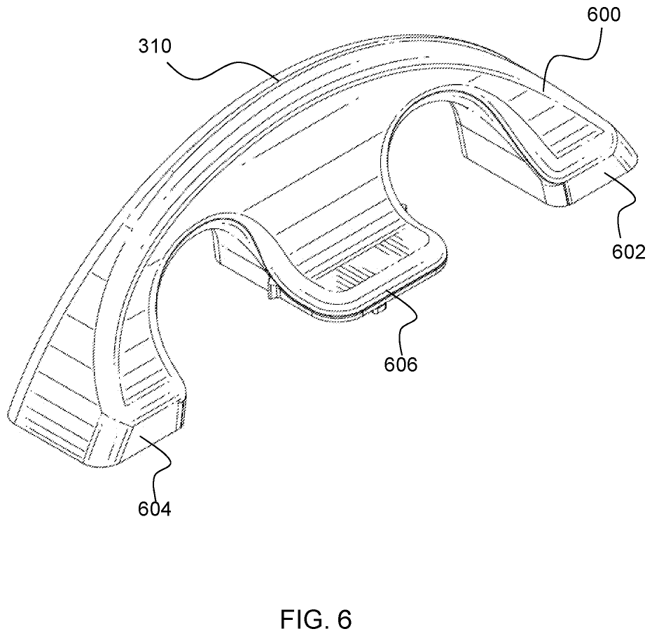

The exterior of the powered massage head 400 may be substantially curved extending from the bottom portion 301 to the top portion 310, as shown in FIG. 4. FIG. 5 illustrates a different embodiment of a stand-alone powered massage head 500, where the powered massage head 500 is substantially straight at its exterior extending from the bottom portion 301 to the top portion 310. FIG. 6 illustrates yet another embodiment of a powered massage head, which is an arched powered massage head 600. The arched powered massage head 600 has a top portion 310 forming an arch having a first end 602, a second end 604, and a central portion 606 between the first end 602 and the second end 604. The first end 602, second end 604, and central portion 606 all contact one of the floor (or other support surface) or a massage board, such as the one depicted in FIG. 2. Each of the powered massage head embodiments shown in FIGS. 4-6 allow for a different sensation when the user rests upon the powered massage head. As can be appreciated by one skilled in the art, the powered massage heads shown in FIGS. 5 and 6 may include a protrusion for attachment to a massage board, similar to the powered massage head depicted in FIG. 1, or may be stand-alone massage heads, such as shown in FIG. 4.

(1.2) Outer Covering for Powered Massage Head

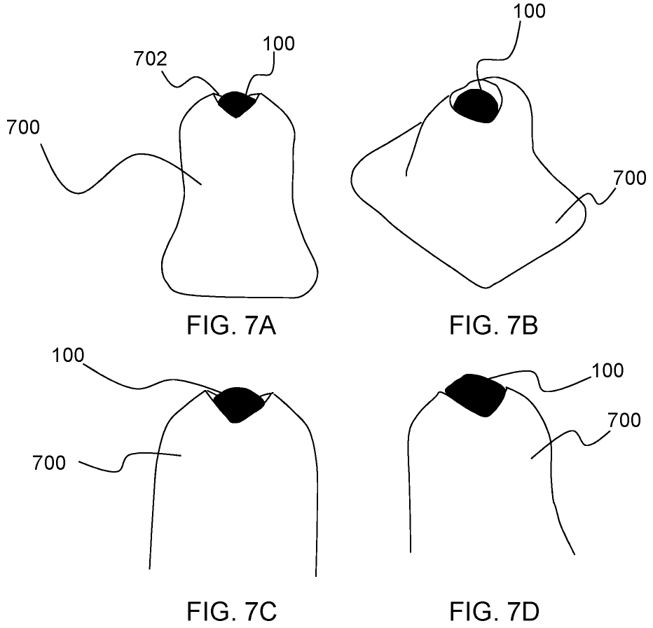

Another embodiment of the powered massage head includes an outer covering that fits over the powered massage head and covers at least portion of the top portion of the powered massage head. The outer covering may be removable or permanently attached with the powered massage head through any suitable mechanism, such as adhesive. The purpose of the outer covering is to sustain the weight of the portion of the user's body that is positioned on the massage head. In the embodiment shown in FIGS. 7A-7D, the outer covering 700 covers the entirety of the powered massage head 100 except for a portion of the top portion. The outer covering 700 comprises an aperture 702 at the top of the outer covering, which is the portion of the top portion that is not covered by the outer covering 700. The aperture 702 provides an opening for the tip of the top portion of the powered massage head 100 to move in and out when it is vibrating. The outer covering 700 may be formed from any suitable material, such as plastic, neoprene, TPE (or any combination thereof). The outer covering 700 may include a rubber edge to provide comfort to the user when the user places their body part (e.g., head, neck, shoulder) on the powered massage head. In one embodiment, a soft, cushioning material, such as neoprene or thermoplastic elastomer (TME), covers the outer covering 700 to prevent any portion of the user's body (e.g., skin) from being pinched between the vibrating/percussion mechanism of the powered massage head and the aperture 702.

FIG. 7A illustrates a front, perspective-view of the outer covering and massage head; FIG. 7B illustrates a top, perspective-view; FIG. 7C illustrates a front view; and FIG. 7D illustrates a front view, showing the top of the massage head 100 coming through the aperture 702. When the massage head 100 protrudes through the aperture 702 in the outer covering 700, at least a portion of the massage head 100 extends beyond the outer covering 700 to directly contact the user's body.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

What is claimed is:

1. A powered massage head system, comprising:
an exterior portion, an interior portion, a top portion, and a bottom portion, wherein the top portion is formed to contact a portion of a user's body;
a motor within the interior portion;
a power source within the interior portion and configured for providing power to the motor; and
a printed circuit board housed within the interior portion and configured for controlling the motor.

2. The powered massage head system as set forth in claim 1, further comprising a protrusion extending from the bottom portion, wherein the protrusion is formed to be removably inserted into a massage board.

3. The powered massage head system as set forth in claim 1, wherein the exterior portion extending from the bottom portion to the top portion is substantially curved.

4. The powered massage head system as set forth in claim 1, wherein the exterior portion extending from the bottom portion to the top portion is substantially straight.

5. The powered massage head system as set forth in claim 1, wherein the top portion forms an arch having a first end and a second end.

6. The powered massage head system as set forth in claim 1, wherein the motor is configured to cause a vibratory action of the exterior portion.

7. The powered massage head system as set forth in claim 1, further comprising an outer covering having an aperture therein, wherein the outer covering fits over at least a portion of the top portion.

8. The powered massage head system as set forth in claim 1, further comprising a control element configured to send signals to the printed circuit board.

9. The powered massage head system as set forth in claim 8, wherein the control element is a wireless remote.

10. The powered massage head system as set forth in claim 8, wherein the control element is a mobile application on a mobile device.

11. A method of forming a powered massage head system, comprising acts of:
forming an exterior portion, an interior portion, a top portion, and a bottom portion, wherein the top portion is formed to contact a portion of a user's body;
positioning a motor within the interior portion;
positioning a power source within the interior portion and connecting the power source with the motor;
configuring the power source to provide power to the motor; and
positioning a printed circuit board configured to control the motor within the interior portion.

12. The method as set forth in claim 11, further comprising an act of forming a protrusion extending from the bottom portion, wherein the protrusion is formed to be removably inserted into a massage board.

13. The method as set forth in claim 11, further comprising an act of forming the exterior portion extending from the bottom portion to the top portion to be substantially curved.

14. The method as set forth in claim 11, further comprising an act of forming the exterior portion extending from the bottom portion to the top portion to be substantially straight.

15. The method as set forth in claim 11, further comprising an act of forming the top portion as an arch having a first end and a second end.

16. The method as set forth in claim 11, further comprising acts of:
forming an outer covering having an aperture therein; and
positioning the outer covering over at least a portion of the top portion of the massage head.
